(19) United States
(12) Patent Application Publication
(10) Pub. No.: US 2007/0238594 A1
(43) Pub. Date: Oct. 11, 2007

(54) Protective shoe carrier bag for traveling and home storage

(76) Inventors: Diana Fisher Horner, McKinney, TX (US); Lyda Emma Fisher, McKinney, TX (US)

Correspondence Address: Diana Fisher Horner, 4312 Clifton Lane, McKinney, TX, 75070, US

(21) Appl. No.: 11/389,964

(22) Filed: Mar. 28, 2006

(51) Int. Cl. B31B 1/62

(52) U.S. Cl. 493/148

(57) ABSTRACT

A protective shoe carrier for protecting shoes packed into a travel bag or suitcase and a protective shoe carrier for home storage use. The cushioned shoe carrier is used to protect the shoes in a travel bag or in a suitcase. The cushioned shoe carrier is coupled to the shoe and is used to protect the surface of the shoe and to protect the surrounding items from being damaged by the sole of the shoe, when the shoe is placed on top of other items contained in the travel bag or suitcase. The shoe carrier is also used for home storage to protect the shoes from damage when not worn and provide easy access to packing shoes into a travel bag or suitcase.

### BACKGROUND OF THE INVENTION

1. Field of the Invention

This invention relates to a protective shoe carrier for protecting shoes packed inside a travel bag or suitcase and a protective shoe carrier for home storage. The cushioned shoe carrier is used to protect the shoes in a travel bag or in a suitcase. The cushioned shoe carrier is coupled to the shoe and is used to protect the surface of the shoe and to protect the surrounding items from being damaged by the sole of the shoe, when the shoe is placed on top of other items contained in the travel bag or suitcase. The shoe carrier is also used for home storage to protect the shoes from damage when not worn and provide easy access to packing shoes into a travel or suitcase.

2. Description of Prior Art

Many people pack their shoes with their clothing in their travel bag or suitcase. The shoes, boots and or sneakers have soles that soil from their use and tear existing clothing from their sharp edges. Many individuals store their shoes inside a closet on a shelf or some type of place where the shoes are stuffed inside a small space. Boots and sneakers often are stored on the floor of the closet. The shoes often get full of dust and can often be a new toy for an untrained puppy or child.

Therefore, a need existed to provide a protective cushioned shoe carrier that can have a protective use for shoes, boots and sneakers when traveling and also have a storage use for home. A cushioned, easily accessible, color coated to the shoe is easy to use for packing for a trip. A protective cushioned shoe carrier protects clothing and other items in a travel bag or suitcase from being damaged or soiled and protects the shoes from being damaged by other travel items. It can also serve to keep shoes stored in the home free from damage and dust build up.

### SUMMARY OF THE INVENTION

In accordance with one embodiment of the present invention, a protective shoe carrier for protecting shoes from damage or damaging other items when packing for travel and for home storage is disclosed.

In accordance with another embodiment of the present invention, a method of providing multiple shaped and sized protective shoe carriers to fit shoes, sneakers and boots for children, men and women packing or storing shoes in a travel bag suitcase or shelf at home.

In accordance with another embodiment of the present invention, a method of providing an outer lining color coated to the shoe coupled with a description shoe tag to take shoes directly from storage to placement directly inside a travel bag or suitcase. And from a travel bag or suitcase back to home storage.

The foregoing and the other objects, features, and advantages of the invention will be apparent from the following, more particular, and description of the preferred embodiments of the invention, as illustrated in the accompanying drawing.

### BRIEF DESCRIPTION OF THE DRAWINGS

FIG. 1 is a back view of the present invention in use with the mechanism to open/close the mechanism in a closed position.

FIG. 2 is a front view of the present invention in use with the mechanism to open/close the mechanism in an open position.

FIG. 3 is a front view of the present invention in use with the mechanism to open/close the mechanism in an open position.

FIG. 4 is a right side view of the present invention in use.

FIG. 5 is a right side view of the present invention in use.

FIG. 6 is a front view of the present invention in use with the mechanism to open/close the mechanism in a closed position.

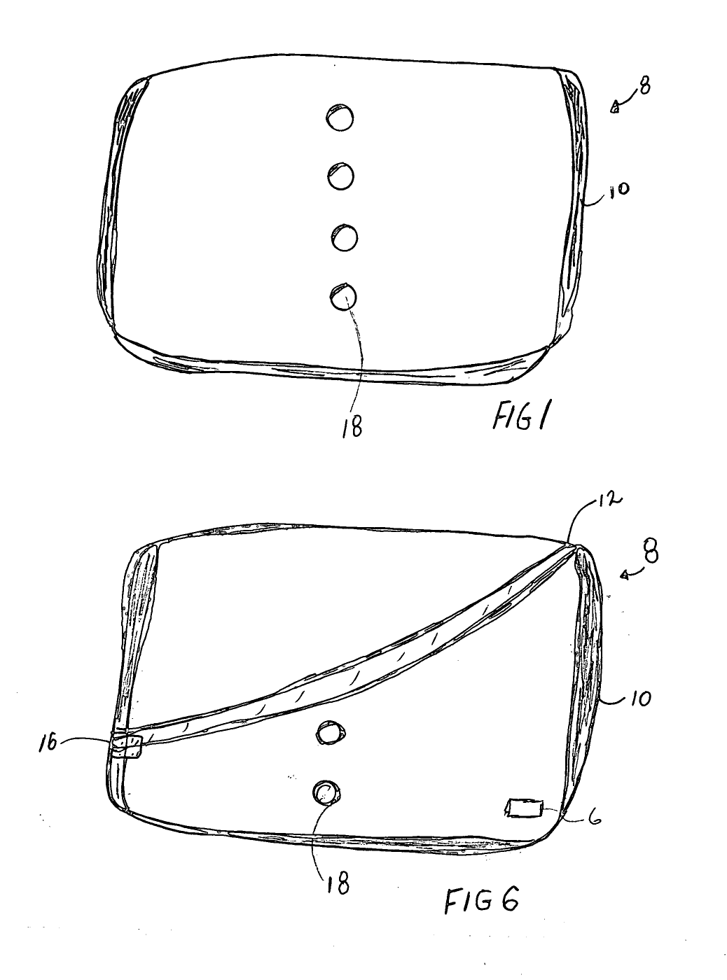

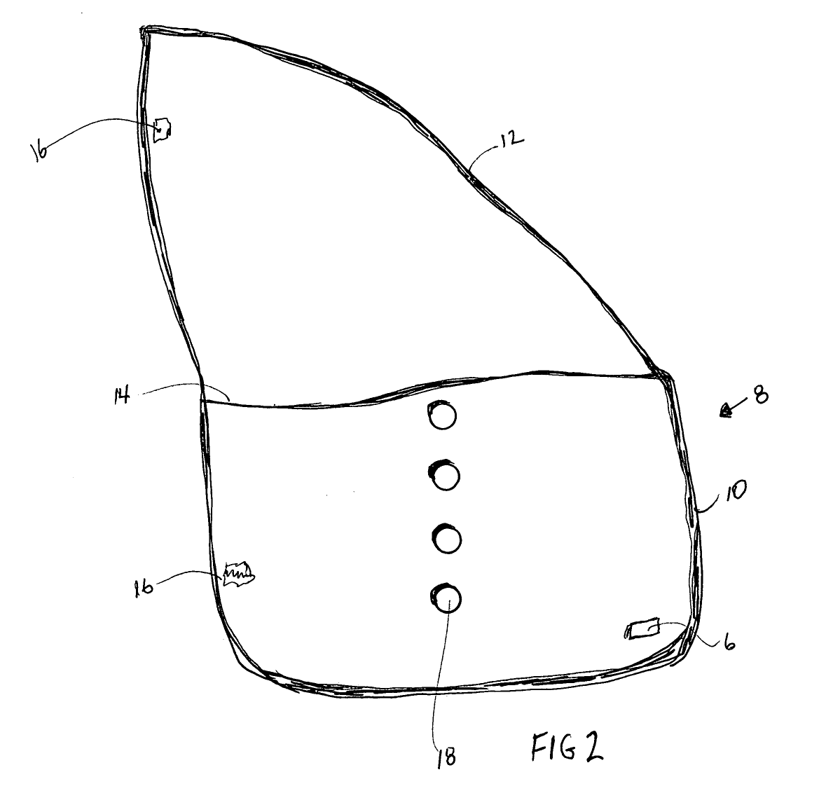

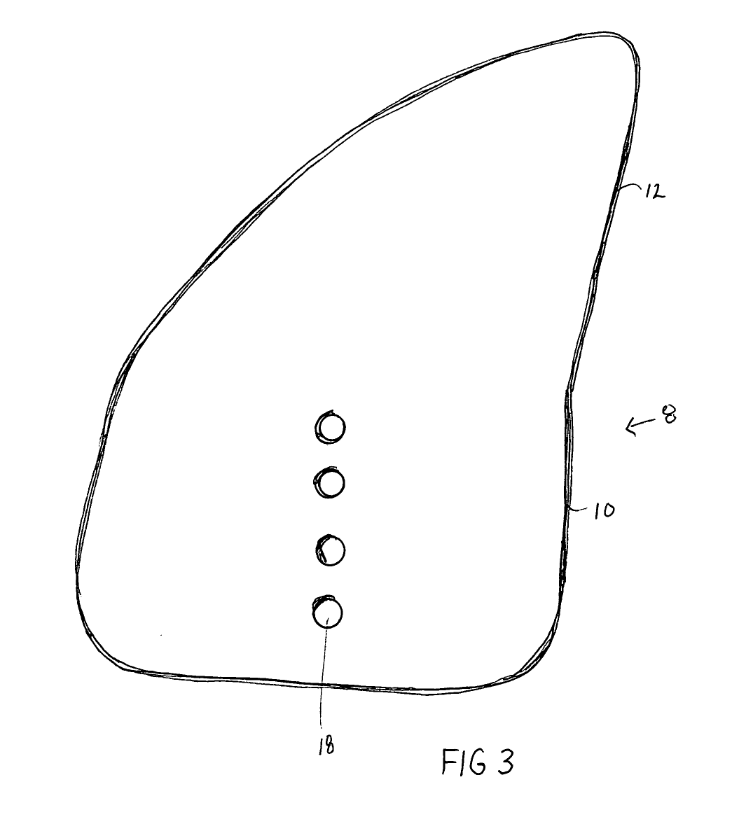

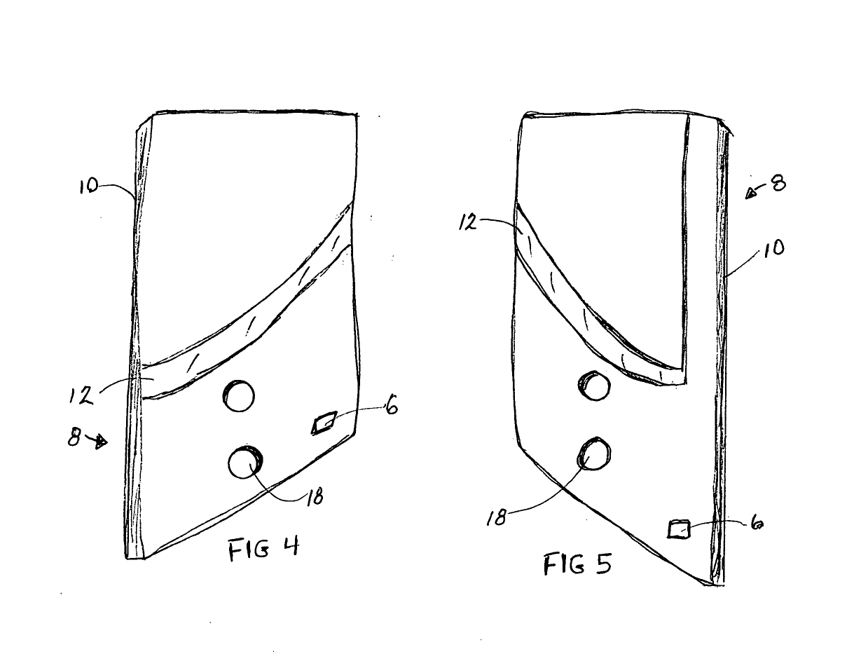

### DETAILED DESCRIPTION OF THE PREFERRED EMBODIMENT

The carrier 8 is designed to serve two main functions. First the carrier 8 is used for protecting shoes, boots and sneakers from damage or from damaging other items inside a travel bag, suitcase and home. The carrier 8 is further designed to use in home storage of shoes, sneakers and boots, thus providing easy access to shoes when packing for travel.

The carrier 8 shown uses a rectangular shape with a standard size shoe carrier 10 for protecting and storing shoes. (Not shown). For example the shoe carrier 10 may be shaped as a square, circle and the like with a shoe sized carrier of exceeding a standard size shoe carrier 10 when used for men's shoes and a smaller sized shoe carrier 10 when used for children. It should be noted that the above listed shapes and sizes only serve as examples and should not be seen as to limit the scope of the patent.

The shoe carrier 10 is made out of an outer durable material with heavily cushioned inner lining material 14. For example the shoe carrier 10 may be made of plastic, cotton, polyester cloth, nylon, silk and the like color coated to match the shoe inside the shoe carrier 10. It should be noted that the above listed materials, shapes and sizes only serve as examples and should not be seen as to limit the scope of the patent. The shoe carrier 10 may have further have one or more sections in one of the listed material or may be made entirely out of a strong durable plastic or leather, color coated to match the shoe inside the shoe carrier 10.

An opening and closing mechanism 12 is coupled to the carrier 8. The mechanism 12 is used to open and to close the carrier 8. Thereby allowing an individual to remove and safely store the shoes, boots and sneakers in the carrier 8. The mechanism 12 may be a flap of any shape coupled with a Velcro strip 16 (as shown) to seal the mechanism closed.

For example to seal the mechanism 16 a zipper, buttons, hook and loop, drawstring, and the like may be used. It should be noted that the above listed mechanisms only serve as examples and should not be seen as to limit the scope of the patent.

The shoe carrier 10 is coupled with snaps 18 located on the back and front of the shoe carrier 10. The snaps 18 are in a linear line with each snap aligned to its counterpart respectively the front to the back of the shoe carrier 10. The snaps 18 are used to separate the space inside of the shoe carrier, thereby allowing the individual to place each shoe, boot and sneaker into its individual pocket inside the shoe carrier 10. For example the shoe carrier 10 may use a large Velcro strip, zipper and the like to form the linear line necessary to serve as the same function as the clasps 18. It should be noted that the above listed materials only serve as examples and should not be seen as to limit the scope of the patent.

The shoe carrier 10 is coupled with a shoe tag 6 in the preferred embodiment of the present invention used for identification and description of the shoes, boots and sneakers located inside the carrier 8. For example the tag 6 may be made of a clear plastic or transparent material to be visible to the individual what is inside the carrier 8. It should be noted that the above listed materials only serve as examples and should not be seen as to limit the scope of the patent.

1. A method of protecting shoes packed inside a travel bag or suitcase when traveling. A method of providing easy access to shoes for packing a travel bag. A method of home storage for shoes comprising, in combination, the steps of:
1. Providing a protective cushion material having a top and bottom with an open slip to place shoes, remove shoes and insert shoes into said shoe carrier.
2. The method of claim 1 wherein said protective shoe carrier further comprises the prevention of damage to the shoes in travel and to other items in the travel bag or suitcase.
3. The method of claim 1 wherein said protective shoe carrier further comprises the step of providing a color coated outer lining coupled with a description shoe tag to take shoes directly from storage to placement inside travel bag or suitcase. And from travel bag back to home storage.
4. The method of claim 1 wherein said protective shoe carrier further comprises the step of providing multiple shaped and sized protective shoe carriers to fit shoes, sneakers and boots for children, men and women packing or storing shoes in a travel bag, suitcase or shelf at home.
